(19) United States
(12) Patent Application Publication
(10) Pub. No.: US 2017/0152360 A1
(43) Pub. Date: Jun. 1, 2017

(54) CYCLIC OLEFIN RESIN COMPOSITION FILM

(71) Applicant: DEXERIALS CORPORATION, Tokyo (JP)

(72) Inventors: Kanako HASHIMOTO, Miyagi (JP); Akihiro HORII, Miyagi (JP); Kei OBATA, Miyagi (JP); Ken HOSOYA, Miyagi (JP); Taku ISHIMORI, Miyagi (JP); Kazuki HIRATA, Miyagi (JP)

(73) Assignee: DEXERIALS CORPORATION, Tokyo (JP)

(21) Appl. No.: 15/323,868

(22) PCT Filed: Jul. 10, 2015
(86) PCT No.: PCT/JP2015/069892

§ 371 Date: Jan. 4, 2017

(30) Foreign Application Priority Data
Jul. 11, 2014 (JP) 2014-143678

(51) Int. Cl. C08J 5/18; G02B 1/14; G02B 1/18; B29C 47/00; B29D 7/01

(52) U.S. Cl. CPC C08J 5/18; B29C 47/0004; B29C 47/0021; B29D 7/01; G02B 1/18; G02B 1/14; B29K 2023/08

(57) ABSTRACT

A cyclic olefin resin composition film having excellent anti-blocking properties and toughness. The cyclic olefin resin composition film containing a cyclic olefin resin and a styrene-based elastomer; the cyclic olefin resin composition film having a first surface layer part having a thickness of from 25 to 45% of total thickness, a second surface layer part having a thickness of from 25 to 45% of the total thickness, and an internal part having thickness of from 10 to 50% of the total thickness between the first surface layer part and the second surface layer part; an average value of minor-axis dispersion diameter of the styrene-based elastomer in the first surface layer part or the second surface layer part being from 75 to 125% of an average value of minor-axis dispersion diameter of the styrene-based elastomer of the internal part. As result, it is possible to achieve excellent anti-blocking properties and toughness.

### TECHNICAL FIELD

The present invention relates to a cyclic olefin resin composition film prepared by adding and dispersing an elastomer or the like into a cyclic olefin resin. The present application claims priority on the basis of Japanese Patent Application No. 2014-143678 filed on Jul. 11, 2014 in Japan, and this application is incorporated into the present application by reference.

### BACKGROUND ART

Cyclic olefin resins are amorphous, thermoplastic olefin resins having a cyclic olefin skeleton in the main chain thereof, and cyclic olefin resins have excellent optical characteristics (transparency and low birefringence) as well as excellent performance in terms of low water absorption and dimensional stability and high moisture resistance based on low water absorption. Thus, films or sheets made of cyclic olefin resins are expected to be developed for various optical applications such as phase difference films, polarizing plate protective films, light diffusion boards, or moisture-resistant packaging applications such as drug packaging and food product packaging.

Cyclic olefin resin films have poor toughness, and it is known that the toughness can be enhanced by adding and dispersing an elastomer or the like having a hard segment and a soft segment (for example, see Patent Documents 1 to 4).

In the production of these films, cutting with an automatic cutter and the joining of the films, which is called splicing, are ordinarily performed at the time of changing between rolls. However, when the film cannot be cut easily, the film may be caught in the roll to be replaced. In addition, when the film is easily torn, the runnability may be diminished due to surface irregularities of the splice part, and the film may be torn. Furthermore, for the purpose of workability and safety, there is a demand for a film that can be easily cut with the fingertips without using a jig such as scissors or a cutter.

### CITATION LIST

### Patent Literature

Patent Document 1: Japanese Unexamined Patent Application Publication No. 2004-156048A

Patent Document 2: Japanese Unexamined Patent Application Publication No. 2000-345122A

Patent Document 3: Japanese Unexamined Patent Application Publication No. H5-220836A

Patent Document 4: Japanese Unexamined Patent Application Publication No. H6-344436A

### SUMMARY OF INVENTION

### Technical Problem

The present invention was conceived in light of the current circumstances described above, and the present invention provides a cyclic olefin resin composition film having excellent workability.

### Solution to Problem

The present inventors discovered that excellent workability can be achieved by adding a styrene-based elastomer to a cyclic olefin resin, setting the average value of minor-axis dispersion diameter of the styrene-based elastomer to not greater than a prescribed value, and defining the tear strength of the cyclic olefin resin composition film in the major-axis direction and the minor-axis direction of the styrene-based elastomer, and the present inventors thereby completed the present invention.

That is, the present invention is a cyclic olefin resin composition film containing a cyclic olefin resin and a styrene-based elastomer; an average value of minor-axis dispersion diameter of the styrene-based elastomer being not greater than 2.0 μm; a tear strength of the cyclic olefin resin composition film in a major-axis direction of the styrene-based elastomer being not greater than 70 N/mm; and a tear strength of the cyclic olefin resin composition film in a minor-axis direction of the styrene-based elastomer being not less than 90 N/mm.

In addition, the production method for a cyclic olefin resin composition film of the present invention is a production method for a cyclic olefin resin composition film including: heat-melting a cyclic olefin resin and a styrene-based elastomer; and extruding the heat-melted cyclic olefin resin composition into a film with an extrusion method, so as to obtain a cyclic olefin resin composition film; an average value of minor-axis dispersion diameter of the styrene-based elastomer being not greater than 2.0 μm; a tear strength of the cyclic olefin resin composition film in a major-axis direction of the styrene-based elastomer being not greater than 70 N/mm; and a tear strength of the cyclic olefin resin composition film in a minor-axis direction of the styrene-based elastomer being not less than 90 N/mm.

Furthermore, the cyclic olefin resin composition film of the present invention may be suitably applied to transparent conductive elements, input devices, display devices, and electronic equipment.

### Advantageous Effects of Invention

According to an embodiment of the present invention, the average value of minor-axis dispersion diameter of the styrene-based elastomer is not greater than a prescribed value, and the film has mechanical anisotropy in which the film does not readily break in the MD and readily breaks in the TD, so it is possible to achieve excellent workability.

### BRIEF DESCRIPTION OF DRAWINGS

FIG. 1 is a cross-sectional perspective view illustrating an overview of the cyclic olefin resin composition film of the present embodiment.

FIG. 2 is a schematic view illustrating an example of the configuration of a film production device.

FIGS. 3A and 3B are cross-sectional views illustrating examples of a transparent conductive film, and FIGS. 3C and 3D are cross-sectional views illustrating examples of a transparent conductive film provided with a moth-eye structure.

FIG. 4 is a schematic cross-sectional view illustrating an example of the configuration of a touchscreen.

FIG. 5 is an external view illustrating an example of a television as a type of electronic equipment.

FIGS. 6A and 6B are external views illustrating examples of a digital camera as a type of electronic equipment.

FIG. 7 is an external view illustrating an example of a laptop personal computer as a type of electronic equipment.

FIG. 8 is an external view illustrating an example of a video camera as a type of electronic equipment.

FIG. 9 is an external view illustrating an example of a mobile telephone as a type of electronic equipment.

FIG. 10 is an external view illustrating an example of a tablet computer as a type of electronic equipment.

### DESCRIPTION OF EMBODIMENTS

Embodiments of the present invention will be described in detail hereinafter in the following order with reference to the drawings.

1. Cyclic olefin resin composition film

2. Production method for cyclic olefin resin composition film

3. Example of application to electronic equipment

4. Examples

### 1. Cyclic Olefin Resin Composition Film

The cyclic olefin resin composition film of this embodiment contains a cyclic olefin resin and a styrene-based elastomer. In addition, in the cyclic olefin resin composition film, the average value of minor-axis dispersion diameter of the styrene-based elastomer is not greater than 2.0 μm; the tear strength of the cyclic olefin resin composition film in the major-axis direction of the styrene-based elastomer is not greater than 70 N/mm; and the tear strength of the cyclic olefin resin composition film in the minor-axis direction of the styrene-based elastomer is not less than 90 N/mm. As a result, the cyclic olefin resin composition film has mechanical anisotropy in which the film does not readily break in the MD (machine direction) and readily breaks in the TD (transverse direction), so it is possible to achieve excellent workability.

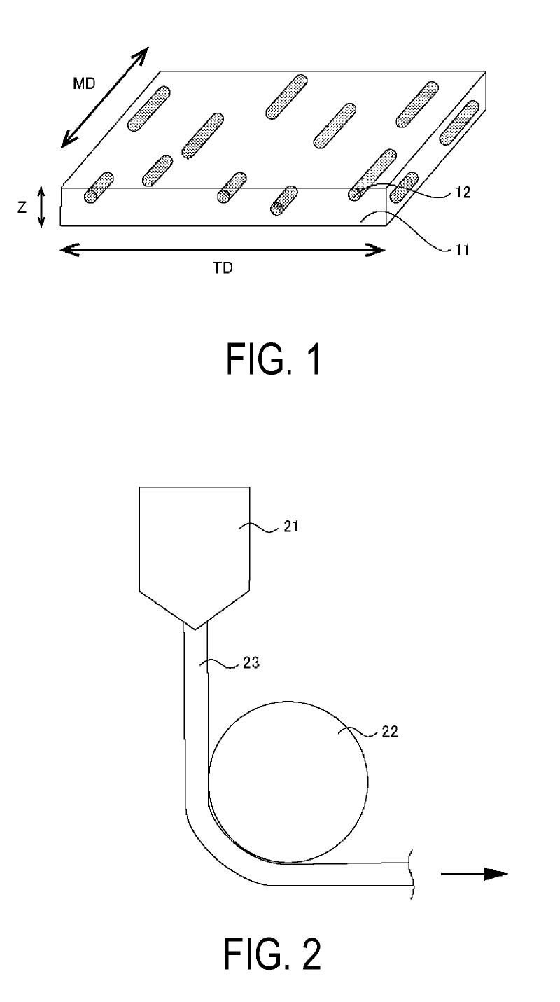

FIG. 1 is a cross-sectional perspective view illustrating an overview of the cyclic olefin resin composition film of this embodiment. As illustrated in FIG. 1, the cyclic olefin resin composition film contains a cyclic olefin resin 11 and a styrene-based elastomer 12.

The cyclic olefin resin composition film is a rectangular film or sheet and has an X-axis direction serving as a transverse direction (TD), a Y-axis direction serving as a machine direction (MD), and a Z-axis direction serving as a thickness direction. The thickness Z of the cyclic olefin resin composition film is preferably from 0.1 μm to 2 mm and more preferably from 1 μm to 1 mm.

In addition, as illustrated in FIG. 1, the cyclic olefin resin composition film has a dispersed phase (island phase) made of the styrene-based elastomer 12 dispersed in a matrix (sea phase) made of the cyclic olefin resin 11. The dispersed phase is dispersed with shape anisotropy in the MD by extrusion, for example, so as to have a major axis of the dispersed phase in the MD and a minor axis of the dispersed phase in the TD.

The minor-axis dispersion diameter of the styrene-based elastomer 12 is preferably not greater than 2.0 μm and more preferably not greater than 1.0 μm. If the minor-axis dispersion diameter is too large, gaps will be developed between the styrene-based elastomer and the cyclic olefin resin due to change in styrene-based elastomer phase under environmental storage, and the refractive index of the styrene-based elastomer changes, which results in a large change in the haze of the entire film.

Note that in this specification, the minor-axis dispersion diameter refers to the size of the dispersed phase made of the styrene-based elastomer 12 in the TD and can be measured as follows. First, the cyclic olefin resin composition film is cut to expose a cross section in TD-thickness (Z-axis). The film cross section is then magnified and observed. The minor axis of each dispersed phase within a prescribed range in the center of the film cross section is measured, and the average value thereof is defined as the minor-axis dispersion diameter. If the dispersion diameter is small, the film is preferably cut after being subjected to osmium staining.

Furthermore, the tear strength of the cyclic olefin resin composition in the major-axis direction of the styrene-based elastomer is not greater than 70 N/mm, and the tear strength in the minor-axis direction of the styrene-based elastomer is not less than 90 N/mm. That is, the tear strength in the MD resulting in tearing in the TD when the film is pulled in the MD is not greater than 70 N/mm, and the tear strength in the TD resulting in tearing in the MD when the film is pulled in the TD is not less than 90 N/mm. As a result, the cyclic olefin resin composition film has mechanical anisotropy in which the film does not readily break in the MD and readily breaks in the TD, so it is possible to achieve excellent roll traveling stability. In addition, the film can be easily cut in the TD with the fingertips without using a jig such as scissors or a cutter, which yields excellent workability.

Furthermore, the tear strength of the cyclic olefin resin composition film in the major-axis direction of the styrene-based elastomer is preferably not less than 40 N/mm, and the difference between the tear strength in the major-axis direction of the styrene-based elastomer and the tear strength in the minor-axis direction of the styrene-based elastomer is preferably not less than 40 N/mm. As a result, it is possible to achieve excellent toughness.

In addition, in the cyclic olefin resin composition film, the added amount of the styrene-based elastomer is preferably less than 35 wt. % and more preferably not less than 5 wt. % and not greater than 30 wt. %. When the added amount of the styrene-based elastomer is too large, retardation in the in-plane direction tends to become large, and when the added amount is too small, sufficient toughness cannot be achieved.

Furthermore, the retardation in the in-plane direction of the cyclic olefin resin composition film is preferably not greater than 30 nm. As a result, it is possible to apply the film as, for example, a member used indirectly during a production/evaluation process of a liquid crystal display; for example, as an adhesive tape for reinforcement or a protective cover for a panel.

The cyclic olefin resin 11 and the styrene-based elastomer 12 will be described in detail hereinafter.

Cyclic Olefin Resin

The cyclic olefin resin is a polymer compound that has the main chain including a carbon-carbon bond and has a cyclic hydrocarbon structure in at least part of the main chain. This cyclic hydrocarbon structure is introduced by using a compound (cyclic olefin) having at least one olefinic double bond in the cyclic hydrocarbon structure, represented by norbornene or tetracyclododecene, as a monomer.

Cyclic olefin resins are classified as follows: addition (co)polymers of cyclic olefins or hydrogenated products thereof (1); addition copolymers of cyclic olefins and α-olefins or hydrogenated products thereof (2); and ring-opening (co)polymers of cyclic olefins or hydrogenated products thereof (3).

Specific examples of the cyclic olefins include monocyclic olefins such as cyclopentene, cyclohexene, cyclooctene; cyclopentadiene and 1,3-cyclohexadiene; dicyclic olefins such as bicyclo[2.2.1]hepta-2-ene (common name: norbornene), 5-methyl-bicyclo[2.2.1]hepta-2-ene, 5,5-dimethyl-bicyclo[2.2.1]hepta-2-ene, 5-ethyl-bicyclo[2.2.1]hepta-2-ene, 5-butyl-bicyclo[2.2.1]hepta-2-ene, 5-ethylidene-bicyclo[2.2.1]hepta-2-ene, 5-hexyl-bicyclo[2.2.1]hepta-2-ene, 5-octyl-bicyclo[2.2.1]hepta-2-ene, 5-octadecyl-bicyclo[2.2.1]hepta-2-ene, 5-methylidene-bicyclo[2.2.1]hepta-2-ene, 5-vinyl-bicyclo[2.2.1]hepta-2-ene, and 5-propenyl-bicyclo[2.2.1]hepta-2-ene;

tricyclic olefins such as tricyclo[4.3.0.1^{2,5}]deca-3,7-diene (common name: dicyclopentadiene), tricyclo[4.3.0.1^{2,5}]deca-3-ene; tricyclo[4.4.0.1^{2,5}]undeca-3,7-diene, tricyclo[4.4.0.1^{2,5}]undeca-3,8-diene, or tricyclo[4.4.0.1^{2,5}]undeca-3-ene as a partially hydrogenated product thereof (or an adduct of cyclopentadiene and cyclohexene); 5-cyclopentyl-bicyclo[2.2.1]hepta-2-ene, 5-cyclohexyl-bicyclo[2.2.1]hepta-2-ene, 5-cyclohexenylbicyclo[2.2.1]hepta-2-ene, and 5-phenyl-bicyclo[2.2.1]hepta-2-ene;

tetracyclic olefins such as tetracyclo[4.4.0.1^{2,5}.1^{7,1}]dodeca-3-ene (also simply called tetracyclododecene), 8-methyltetracyclo[4.4.0.1^{2,5}.1^{7,10}]dodeca-3-ene, 8-ethyltetracyclo[4.4.0.1^{2,5}.1^{7,10}]dodeca-3-ene, 8-methylidenetetracyclo[4.4.0.1^{2,5}.1^{7,10}]dodeca-3-ene, 8-ethylidenetetracyclo[4.4.0.1^{2,5}.1^{7,10}]dodeca-3-ene, 8-vinyltetracyclo[4.4.0.1^{2,5}.1^{7,10}]dodeca-3-ene, and 8-propenyl-tetracyclo[4.4.0.1^{2,5}.1^{7,10}]dodeca-3-ene;

and polycyclic olefins such as 8-cyclopentyl-tetracyclo[4.4.0.1^{2,5}.1^{7,10}]dodeca-3-ene, 8-cyclohexyl-tetracyclo[4.4.0.1^{2,5}.1^{7,10}]dodeca-3-ene, 8-cyclohexenyl-tetracyclo[4.4.0.1^{2,5}.1^{7,10}]dodeca-3-ene, 8-phenyl-cylopentyl-tetracyclo[4.4.0.1^{2,5}.1^{7,10}]dodeca-3-ene; tetracyclo[7.4.1^{3,6}.0^{1,9}.0^{2,7}]tetradeca-4,9,11,13-tetraene (also called 1,4-methano-1,4,4a,9a-tetrahydrofluorene), tetracyclo[8.4.1^{4,7}.0^{1,10}.0^{3,8}]pentadeca-5,10,12,14-tetraene (also called 1,4-methano-1,4,4a,5,10,10a-hexahydroanthracene); pentacyclo[6.6.1.1^{3,6}.0^{2,7}.0^{9,14}]-4-hexadecene, pentacyclo[6.5.1.1^{3,6}.0^{2,7}.0^{9,13}]-4-pentadecene, pentacyclo[7.4.0.0^{2,7}.1^{3,6}.1^{10,13}]-4-pentadecene; heptacyclo[8.7.0.1^{2,9}.1^{4,7}.1^{11,17}.0^{3,8}.0^{12,16}]-5-eicosene, heptacyclo[8.7.0.1^{2,9}.0^{3,8}.1^{4,7}.0^{12,17}.1^{13,16}]-14-eicosene; and tetramers of cyclopentadiene. These cyclic olefins may each be used alone, or two or more types may be used in combination.

Specific examples of the α-olefins that are copolymerizable with cyclic olefins include α-olefins having from 2 to 20 carbons, preferably from 2 to 8 carbons, such as ethylene, propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, and 1-eicosene. These α-olefins may each be used alone, or two or more types may be used in combination. Compositions in which these α-olefins are contained within a range of from 5 to 200 mol % with respect to the cyclic polyolefin may be used.

The polymerization method of the cyclic olefin or the cyclic olefin and the α-olefin, and the hydrogenation method of the resulting polymer are not particularly limited, and these processes may be performed in accordance with publicly known methods.

In the present embodiment, an addition copolymer of ethylene and norbornene is preferably used as a cyclic olefin resin.

The structure of the cyclic olefin resin is not particularly limited and may be a chain, branched-chain, or crosslinked structure, but the structure is preferably a straight-chain structure.

The molecular weight of the cyclic olefin resin in terms of the number average molecular weight according to the gel permeation chromatography (GPC) method is from 5,000 to 300,000, preferably from 10,000 to 150,000, and more preferably from 15,000 to 100,000. If the number average molecular weight is too small, the mechanical strength decreases, and if the number average molecular weight is too large, the formability becomes poor.

In addition, cyclic olefin resins may include compositions (4) prepared by graft-polymerizing and/or copolymerizing an unsaturated compound (u) having a polar group (for example, a carboxyl group, an acid anhydride group, an epoxy group, an amide group, an ester group, a hydroxyl group, or the like) in the cyclic olefin resins (1) to (3) described above. Two or more types of the cyclic olefin resins (1) to (4) described above may be mixed and used.

Examples of the unsaturated compound (u) described above include (meth)acrylic acid, maleic acid, maleic anhydride, itaconic anhydride, glycidyl(meth)acrylate, alkyl (meth)acrylate (1 to 10 carbons) esters, alkyl maleate (1 to 10 carbons) esters, (meth)acrylamide, and 2-hydroxyethyl (meth)acrylate.

The affinity with metals or polar resins can be enhanced by using a modified cyclic olefin resin (4) prepared by graft-polymerizing and/or copolymerizing an unsaturated compound (u) having a polar group, so the strength after various secondary processes, such as vapor deposition, sputtering, coating, and adhesion, can be enhanced, which is preferable when secondary processing is necessary. However, there is a drawback in that the presence of a polar group may increase the water absorption rate of the cyclic olefin resin. Therefore, the content of the polar group (for example, a carboxyl group, an acid anhydride group, an epoxy group, an amide group, an ester group, a hydroxyl group, or the like) is preferably from 0 to 1 mol/kg per 1 kg of the cyclic olefin resin.

### Styrene-Based Elastomer

A styrene-based elastomer is a copolymer of styrene and a conjugated diene such as butadiene or isoprene, and/or a hydrogenated product thereof. A styrene-based elastomer is a block copolymer having styrene as a hard segment and a conjugated diene as a soft segment. The structure of the soft segment changes the storage modulus of the styrene-based elastomer, and the content of styrene serving as a hard segment changes the refractive index and changes the haze of the entire film. A styrene-based elastomer is preferably used in that a vulcanization process is unnecessary. In addition, a hydrogenated composition is more preferable in that the thermal stability is higher.

Examples of the styrene-based elastomers include styrene/butadiene/styrene block copolymers, styrene/isoprene/styrene block copolymers, styrene/ethylene/butylene/styrene block copolymers, styrene/ethylene/propylene/styrene block copolymers, and styrene/butadiene block copolymers.

In addition, styrene/ethylene/butylene/styrene block copolymers, styrene/ethylene/propylene/styrene block copolymers, and styrene/butadiene block copolymers, in which double bonds of the conjugated diene components are eliminated by hydrogenation (also called hydrogenated styrene-based elastomers), or the like may also be used.

The structure of the styrene-based elastomer is not particularly limited and may be a chain, branched-chain, or crosslinked structure, but the structure is preferably a straight-chain structure in order to reduce the storage modulus.

In the present embodiment, one or more types of styrene-based elastomers selected from the group consisting of styrene/ethylene/butylene/styrene block copolymers, styrene/ethylene/propylene/styrene block copolymers, and hydrogenated styrene/butadiene block copolymers are preferably used. In particular, hydrogenated styrene/butadiene block copolymers are more preferably used in that they have high tear strength and a small increase in haze after environmental storage. The ratio of butadiene to styrene in the hydrogenated styrene/butadiene block copolymer is preferably within the range of from 10 to 90 mol % so that the compatibility with the cyclic olefin resin is not lost.

In addition, the styrene content of the styrene-based elastomer is preferably from 20 to 40 mol %. By setting the styrene content to 20 to 40 mol %, it is possible to reduce haze.

The molecular weight of the styrene-based elastomer in terms of the number average molecular weight according to the GPC method is from 5,000 to 300,000, preferably from 10,000 to 150,000, and more preferably from 20,000 to 100,000. If the number average molecular weight is too small, the mechanical strength decreases, and if the number average molecular weight is too large, the formability becomes poor.

### Other Additives

In addition to a cyclic olefin resin and a styrene-based elastomer, various compounding agents may be added to the cyclic olefin resin composition as necessary within a range that does not diminish the characteristics thereof. The various compounding agents are not particularly limited as long as they are agents which are ordinarily used in thermoplastic resin materials, and examples thereof include compounding agents such as inorganic oxide microparticles, antioxidants, UV absorbers, photostabilizers, plasticizers, lubricants, antistatic agents, flame retardants, colorants such as dyes or pigments, near infrared absorbers, and fluorescent brightening agents, fillers, and the like.

A cyclic olefin resin composition film having such a structure has mechanical anisotropy in which the film does not readily break in the MD and readily breaks in the TD, so it is possible to achieve excellent roll traveling stability. In addition, the film can be easily cut in the TD with the fingertips without using a jig such as scissors or a cutter, which yields excellent workability. Furthermore, by setting the added amount of the styrene-based elastomer to not less than 5 wt. % and not greater than 30 wt. %, it is possible to set the retardation Re in the in-plane direction to not greater than 30 nm. If the retardation Re in the in-plane direction is greater than the range described above, it is difficult to utilize the film as a substrate for a polarizing plate, for example.

### 2. Production Method for Cyclic Olefin Resin Composition Film

The production method for a cyclic olefin resin composition film according to the present embodiment is a method for obtaining a cyclic olefin resin composition film comprising heat-melting a cyclic olefin resin and a styrene-based elastomer and extruding the heat-melted cyclic olefin resin composition into a film with an extrusion method, so as to obtain a cyclic olefin resin composition film; an average value of minor-axis dispersion diameter of the styrene-based elastomer being not greater than 2.0 μm; a tear strength of the cyclic olefin resin composition film in a major-axis direction of the styrene-based elastomer being not greater than 70 N/mm; and a tear strength of the cyclic olefin resin composition film in a minor-axis direction of the styrene-based elastomer being not less than 90 N/mm.

The cyclic olefin resin composition film may be an unstretched film, a uniaxially stretched film, or a biaxially stretched film, but the film is preferably unstretched. In the case of ordinary uniaxial stretching, the tear strength in the MD resulting in tearing in the TD when the film is pulled in the MD becomes large, and the tear strength in the TD resulting in tearing in the MD when the film is pulled in the TD becomes small, which makes it difficult to cut the film in the TD. In the case of tenter-type uniaxial stretching, the tear strength in the MD resulting in tearing in the TD when the film is pulled in the MD becomes small, and the tear strength in the TD resulting in tearing in the MD when the film is pulled in the TD becomes large. However, the stretching apparatus becomes structurally complex and expensive, and a phase difference arises in the stretching method, so it is difficult to obtain a desired low-phase-difference film.

FIG. 2 is a schematic view illustrating an example of the configuration of a film production device. The film production device includes a die 21 and a roll 22. The die 21 is a die for melt forming, and the die extrudes a resin material 23 in a molten state into a film. The resin material 23 contains, for example, the cyclic olefin resin composition described above. The roll 22 plays a role of conveying the resin material 23 extruded into a film from the die 21. In addition, the roll 22 has a medium flow path inside, and the surface temperature can be adjusted to any temperature by separate temperature adjustment devices. Furthermore, the material of the surface of the roll 22 is not particularly limited, and a metal rubber, resin, elastomer, or the like may be used.

In the present embodiment, a cyclic olefin resin composition containing the cyclic olefin resin and styrene-based elastomer described above is used as the resin material 23 and is melted and mixed at a temperature within the range of from 210° C. to 300° C. A higher melting temperature tends to yield a smaller minor-axis dispersion diameter of the styrene-based elastomer.

### 3. Example of Application to Electronic Equipment

The cyclic olefin resin composition film of the present embodiment may be applied to various optical applications such as phase difference films, polarizing plate protective films, light diffusion boards, and the like; in particular, applications for prism sheets and liquid crystal cell substrates. An application example in which the cyclic olefin resin composition film is used as a phase difference film will be described hereinafter.

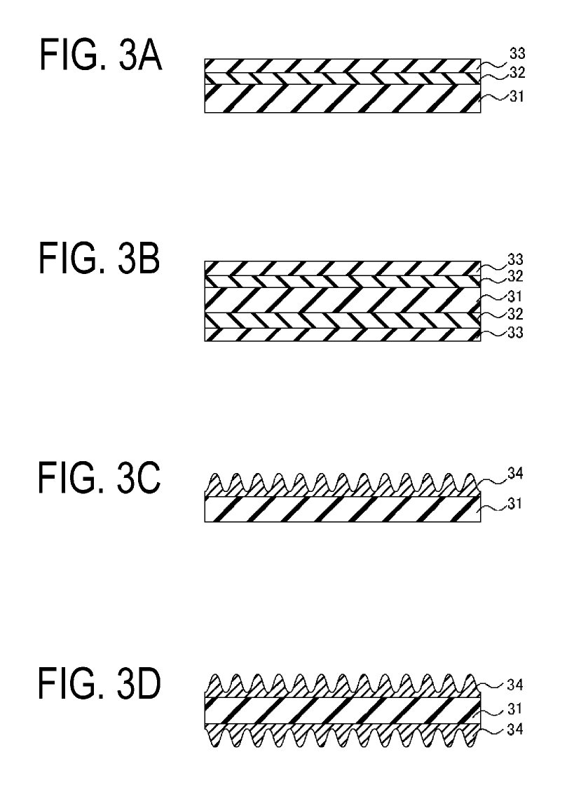

FIGS. 3A and 3B are cross-sectional views illustrating examples of a transparent conductive film. The transparent conductive film (transparent conductive element) includes the cyclic olefin resin composition film described above as a base film (substrate). Specifically, the transparent conductive film includes a phase difference film 31 as a base film (substrate) and a transparent conductive layer 33 on at least one surface of the phase difference film 31. FIG. 3A is an example in which the transparent conductive layer 33 is provided on one surface of the phase difference film 31, and FIG. 3B is an example in which the transparent conductive layers 33 are each provided on both surfaces of the phase difference film 31. As illustrated in FIGS. 3A and 3B, a hard coat layer 32 may be further provided between the phase difference film 31 and the transparent conductive layer 33.

One or more types of materials selected from the group consisting of electrically conductive metal oxide materials, metal materials, carbon materials, conductive polymers, and the like, for example, may be used as the material of the transparent conductive layer 33. Examples of the metal oxide materials include indium tin oxide (ITO), zinc oxide, indium oxide, antimony-added tin oxide, fluorinated tin oxide, aluminum-added zinc oxide, gallium-added zinc oxide, silicon-added zinc oxide, zinc oxide-tin oxide, indium oxide-tin oxide, and zinc oxide-indium oxide-magnesium oxide. Metal nanofillers such as metal nanoparticles or metal nanowires, for example, may be used as metal materials. Specific examples of these materials include metals such as copper, silver, gold, platinum, palladium, nickel, tin, cobalt, rhodium, iridium, iron, ruthenium, osmium, manganese, molybdenum, tungsten, niobium, tantalum, titanium, bismuth, antimony, and lead or alloys thereof. Examples of the carbon materials include carbon black, carbon fibers, fullerene, graphene, carbon nanotubes, carbon microcoils, and nanohorns. Substituted or unsubstituted polyaniline, polypyrrole, polythiophene, and (co)polymers or the like comprising one or two types selected from these compositions, for example, may be used as conductive polymers.

A physical vapor deposition (PVD) method such as sputtering, vacuum deposition, or ion plating, a chemical vapor deposition (CVD) method, a coating method, a printing method, or the like may be used as the method for forming the transparent conductive layer 33. The transparent conductive layer 33 may be a transparent electrode having a prescribed electrode pattern. The electrode pattern may be, but is not limited to, a striped pattern or the like.

An ionizing radiation curable resin which is cured by light or an electron beam or a thermosetting resin which is cured by heat is preferably used as the material of the hard coat layer 32, and a photosensitive resin which is cured by ultraviolet rays is most preferable. Acrylate resins such as urethane acrylate, epoxy acrylate, polyester acrylate, polyol acrylate, polyether acrylate, and melamine acrylate, for example, may be used as such a photosensitive resin. For example, a urethane acrylate resin is obtained by reacting an isocyanate monomer or a prepolymer with a polyester polyol and reacting an acrylate or methacrylate monomer having a hydroxyl group with the obtained product. The thickness of the hard coat layer 32 is preferably from 1 μm to 20 μm but is not particularly limited to this range.

In addition, as illustrated in FIGS. 3C and 3D, the transparent conductive film may also be provided with a moth-eye structure 34 as an antireflective layer on at least one surface of the phase difference film described above. FIG. 3C is an example in which the moth-eye structure 34 is provided on one surface of the phase difference film 31, and FIG. 3D is an example in which the moth-eye structure is provided on both surfaces of the phase difference film. Note that, the antireflective layer provided on the surface of the phase difference film 11 is not limited to the moth-eye structure described above, and a conventionally known antireflective layer such as a low refractive index layer may also be used.

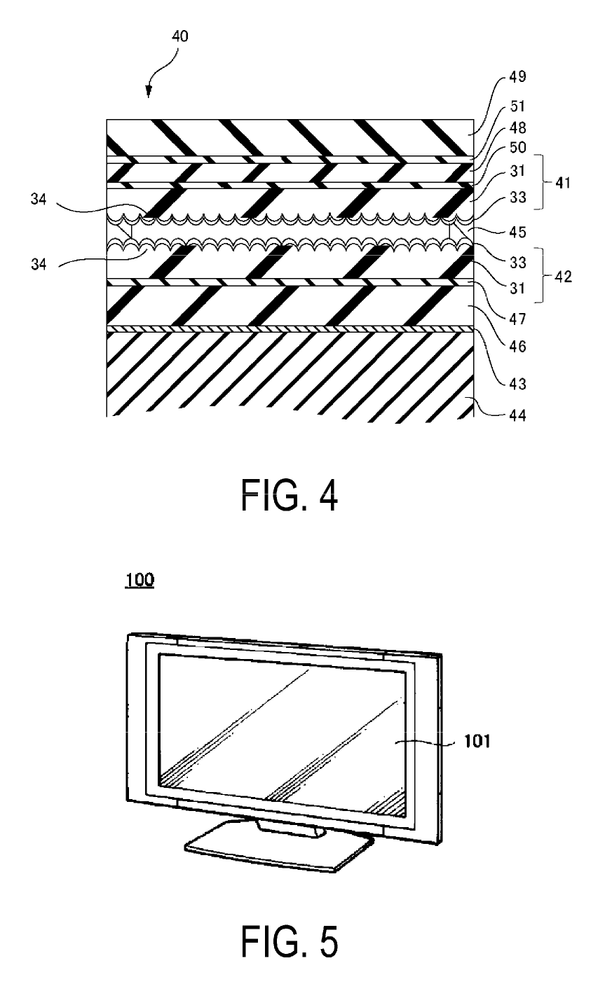

FIG. 4 is a schematic cross-sectional view illustrating an example of the configuration of a touchscreen. The touchscreen (input device) 40 is a so-called resistive film type touchscreen. The resistive film type touchscreen may be an analog resistive film type touchscreen or a digital resistive film type touchscreen.

The touchscreen 40 includes a first transparent conductive film 41 and a second transparent conductive film 42 opposing the first transparent conductive film 41. The first transparent conductive film 41 and the second transparent conductive film 42 are bonded to each other via a bonding part 45 between the peripheries thereof. An adhesive paste, an adhesive tape, or the like is used as the bonding part 45. The touchscreen 40 is bonded to a display 44, for example, via a bonding layer 43. An adhesive such as an acrylic, rubber, or silicone adhesive may be used as the material of the bonding layer 43, and an acrylic adhesive is preferable from the perspective of transparency.

The touchscreen 40 is further provided with a polarizer 48 bonded to the surface of the first transparent conductive film 41 serving as the side that is touched by a user (working side) via a bonding layer 50 or the like. The transparent conductive films described above may be used as the first transparent conductive film 41 and/or the second transparent conductive film 42. However, the phase difference film serving as a base film (substrate) is set to λ/4. The use of the polarizer 48 and the phase difference film 31 can reduce the reflectivity and enhance visibility.

The touchscreen 40 is preferably provided with moth-eye structures 34 on the opposing surfaces of the first transparent conductive film 41 and the second transparent conductive film 42—that is, the surfaces of the transparent conductive layers 33. As a result, it is possible to enhance the optical characteristics (for example, the reflection characteristics, the transmission characteristics, or the like) of the first transparent conductive film 41 and the second transparent conductive film 42.

The touchscreen 40 is preferably further provided with a single or multiple antireflective layers on the surface of the first transparent conductive film 41 serving as the working side. As a result, it is possible to reduce the reflectivity and to enhance visibility.

From the perspective of enhancing scratch resistance, the touchscreen 40 is preferably further provided with a hard coat layer on the surface of the first transparent conductive film 41 serving as the working side. The surface of this hard coat layer is preferably imparted with antifouling properties.

The touchscreen 40 is preferably further provided with a front panel (surface member) 49 bonded to the surface of the first transparent conductive film 41 serving as the working side via a bonding layer 51. In addition, the touchscreen 40 is preferably further provided with a glass substrate 46 bonded to the surface of the second transparent conductive film 42 that is bonded to the display 44 via a bonding layer 47.

The touchscreen 40 is preferably further provided with a plurality of structures on the surface of the second transparent conductive film 42 that is bonded to the display 44 and the like. The anchor effect of the plurality of structures makes it possible to enhance the adhesion between the touchscreen 40 and the bonding layer 43. A moth-eye structure is preferable as this structure. As a result, interface reflection can be suppressed.

Various displays such as a liquid crystal display, a cathode ray tube (CRT) display, a plasma display (PDP), an electro luminescence (EL) display, or a surface-conduction electron-emitter display (SED) may be used as the display 44.

Next, electronic equipment including the input device 40 described above will be described. FIG. 5 is an external view illustrating an example of a television device as a type of electronic equipment. A television device 100 includes a display 101, and a touchscreen 40 provided on the display 101.

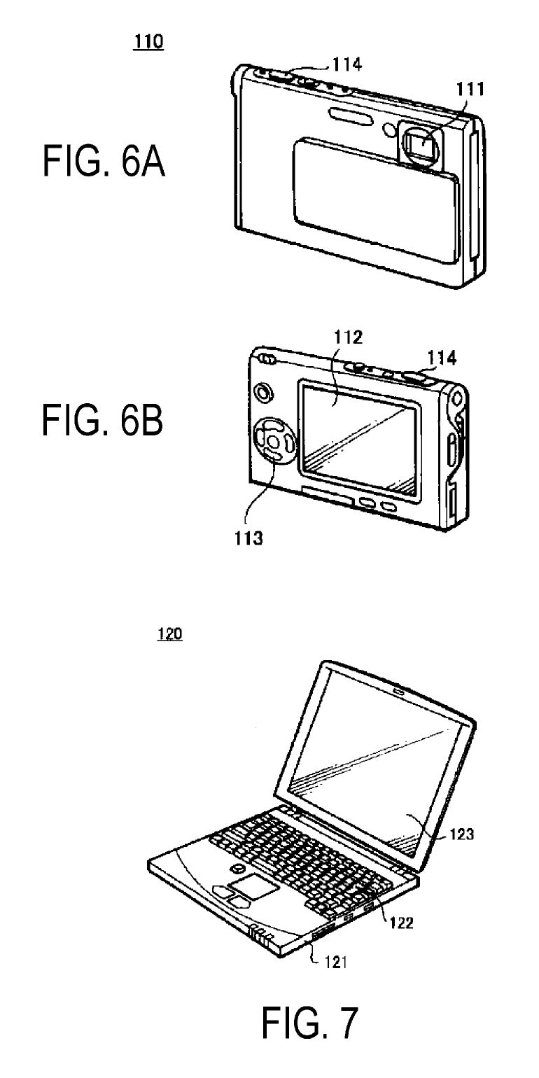

FIGS. 6A and 6B are external views illustrating an example of a digital camera as a type of electronic equipment. FIG. 6A is an external view of the digital camera from the front side, and FIG. 6B is an external view of the digital camera from the back side. A digital camera 110 includes a light-emitting part 111 for a flash, a display 112, a menu switch 113, a shutter button 114, and the like, and the display 112 includes a touchscreen 40 described above.

FIG. 7 is an external view illustrating an example of a laptop personal computer as a type of electronic equipment. A laptop personal computer 120 includes a keyboard 122 for inputting characters, a display 123 for displaying images, and the like on a main body 121, and the display 123 includes a touchscreen 40 described above.

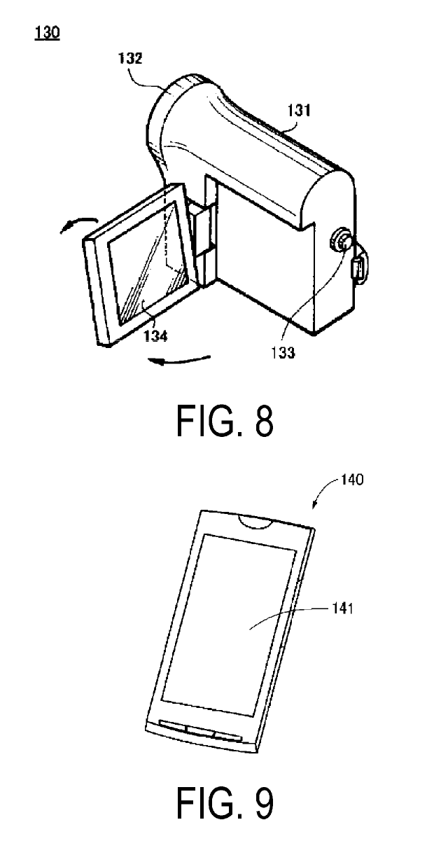

FIG. 8 is an external view illustrating an example of a video camera as a type of electronic equipment. A video camera 130 includes a main body 131, a lens 132 for video-recording an object provided on the front side surface of the main body, a start/stop switch 133 to be used at the time of video-recording, a display 134, and the like, and the display 134 includes a touchscreen 40 described above.

FIG. 9 is an external view illustrating an example of a mobile telephone as a type of electronic equipment. A mobile telephone 140 is a so-called smart phone and includes a touchscreen 40 described above on the display 141 thereof.

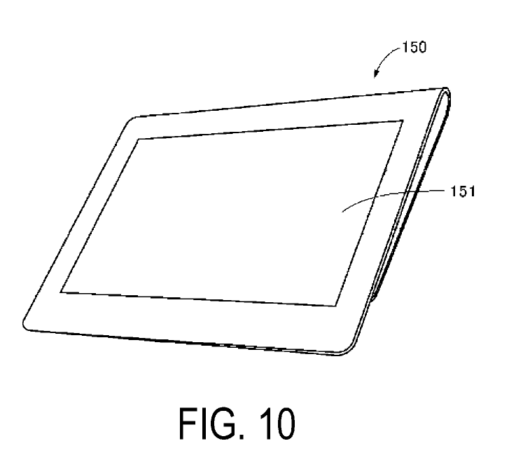

FIG. 10 is an external view illustrating an example of a tablet computer as a type of electronic equipment. A tablet computer 150 includes a touchscreen 40 described above on a display 151 thereof.

In each of the types of electronic equipment described above, a cyclic olefin resin composition film having small in-plane retardation and excellent toughness is used, which enables high durability and high-quality display.

### EXAMPLES

### 4. Examples

Examples of the present invention will be described hereinafter. In these examples, a styrene-based elastomer was added to a cyclic olefin resin to produce a cyclic olefin resin composition film having a prescribed tear strength in the MD and the TD. The retardation and workability of the film was then evaluated. Note that the present invention is not limited to these examples.

The minor-axis dispersion diameter, tear strength, retardation, and workability of the styrene-based elastomer of the cyclic olefin resin composition film were evaluated as follows.

### Minor-Axis Dispersion Diameter Measurement

The cyclic olefin resin composition film was cut to expose a cross section in TD-thickness (Z-axis) using a microtome, and the film cross section was observed using an optical microscope with a magnification of approximately 2,500 times. The minor axes of the styrene-based elastomers within a range of 20 μm×20 μm in the center of the film cross section were measured, and the average value thereof was defined as the minor-axis dispersion diameter of the surface layer part.

### Tear Strength Measurement

A film with a thickness of 80 μm was measured in accordance with JISK 7128. A No. 3 type test piece was used as a test piece, and measurements were performed at a testing speed of 200 mm/min using a tensile tester (AG-X, manufactured by Shimadzu Corporation). The average value of the tear strength in the MD when the test piece is pulled in the MD and the average value of the tear strength in the TD when the test piece is pulled in the TD were calculated.

The tear strength in the MD was evaluated as “Good” when the value was not greater than 70 N/mm and as “Fail” when the value is greater than 70 N/mm. In addition, the tear strength in the TD was evaluated as “Good” when the value was not less than 100 N/mm and as “Fail” when the value was less than 90 N/mm.

### Retardation Measurement

The retardation Re in the in-plane direction of the cyclic olefin resin composition film was measured using the Retardation Film and Material Evaluation System (RETS-100, manufactured by Otsuka Electronics Co., Ltd.).

### Workability Evaluation

Cases in which the tear strength in the MD was not greater than 70 N/mm and the tear strength in the TD was not less than 90 N/mm were evaluated as “Good”, and all other cases were evaluated as “Fail”. As long as the tear strength in the MD is not greater than 70 N/mm and the tear strength in the TD is not less than 90 N/mm, the film can be easily cut by hand while maintaining toughness, so the working efficiency is enhanced.

### Cyclic Olefin Resins and Styrene-Based Elastomers

The following three types were used as cyclic olefin resins.

TOPAS6013-504 (manufactured by Polyplastics Co., Ltd.): addition copolymer of ethylene and norbornene
Zeonoa ZF16 (manufactured by Zeon Corporation): cycloolefin polymer (COP) resin
Zeonoa ZM16 (manufactured by Zeon Corporation): cycloolefin polymer (COP) resin

In addition, the following two types were used as styrene-based elastomers.

S.O.E. L606 (manufactured by Asahi Kasei Corporation): hydrogenated styrene/butadiene block copolymer
Tuftec H1517 (manufactured by Asahi Kasei Corporation): styrene/ethylene/butylene/styrene block copolymer

### Example 1

In this example, 90 wt. % of TOPAS6013-S04 (manufactured by Polyplastics Co., Ltd.) was compounded as a cyclic olefin resin, and 10 wt. % of S.O.E. L606 (manufactured by Asahi Kasei Corporation) was compounded as a styrene-based elastomer. After this was kneaded at a prescribed temperature within the range of from 210° C. to 300° C. using a twin-screw extruder having a T-die attached to the end thereof (specifications: diameter: 25 mm, length: 26D, T-die width: 160 mm), the cyclic olefin resin composition was extruded at a rate of 250 g/min, and a film with a thickness of 80 μm was wound on a roll.

As illustrated in Table 1, the minor-axis dispersion diameter of the styrene-based elastomer in the TD-thickness (Z-axis) cross section of the film was 0.2 μm. In addition, the tear strength in the MD was evaluated as Good at 53 N/mm, while the tear strength in the TD was evaluated as Good at 165 N/mm, and the workability was evaluated as Good. Furthermore, the retardation Re was evaluated as Good at 4 nm.

### Example 2

In this example, 85 wt. % of TOPAS6013-S04 (manufactured by Polyplastics Co., Ltd.) was compounded as a cyclic olefin resin, and 15 wt. % of Tuftec H1517 (manufactured by Asahi Kasei Corporation) was compounded as a styrene-based elastomer. After this was kneaded at a prescribed temperature within the range of from 210° C. to 300° C. using a twin-screw extruder having a T-die attached to the end thereof (specifications: diameter: 25 mm, length: 26D, T-die width: 160 mm), the cyclic olefin resin composition was extruded at a rate of 250 g/min, and a film with a thickness of 80 μm was wound on a roll.

As illustrated in Table 1, the minor-axis dispersion diameter of the styrene-based elastomer in the TD-thickness (Z-axis) cross section of the film was 0.9 μm. In addition, the tear strength in the MD was evaluated as Good at 48 N/mm, while the tear strength in the TD was evaluated as Good at 145 N/mm, and the workability was evaluated as Good. Furthermore, the retardation Re was evaluated as Good at 18 nm.

### Example 3

In this example, 95 wt. % of TOPAS6013-S04 (manufactured by Polyplastics Co., Ltd.) was compounded as a cyclic olefin resin, and 5 wt. % of Tuftec H1517 (manufactured by Asahi Kasei Corporation) was compounded as a styrene-based elastomer. After this was kneaded at a prescribed temperature within the range of from 210° C. to 300° C. using a twin-screw extruder having a T-die attached to the end thereof (specifications: diameter: 25 mm, length: 26D, T-die width: 160 mm), the cyclic olefin resin composition was extruded at a rate of 250 g/min, and a film with a thickness of 80 μm was wound on a roll.

As illustrated in Table 1, the minor-axis dispersion diameter of the styrene-based elastomer in the TD-thickness (Z-axis) cross section of the film was 0.6 μm. In addition, the tear strength in the MD was evaluated as Good at 46 N/mm, while the tear strength in the TD was evaluated as Good at 105 N/mm, and the workability was evaluated as Good. Furthermore, the retardation Re was evaluated as Good at 9 nm.

### Example 4

In this example, 70 wt. % of TOPAS6013-S04 (manufactured by Polyplastics Co., Ltd.) was compounded as a cyclic olefin resin, and 30 wt. % of Tuftec H1517 (manufactured by Asahi Kasei Corporation) was compounded as a styrene-based elastomer. After this was kneaded at a prescribed temperature within the range of from 210° C. to 300° C. using a twin-screw extruder having a T-die attached to the end thereof (specifications: diameter: 25 mm, length: 26D, T-die width: 160 mm), the cyclic olefin resin composition was extruded at a rate of 250 g/min, and a film with a thickness of 80 μm was wound on a roll.

As illustrated in Table 1, the minor-axis dispersion diameter of the styrene-based elastomer in the TD-thickness (Z-axis) cross section of the film was 1.8 μm. In addition, the tear strength in the MD was evaluated as Good at 69 N/mm, while the tear strength in the TD was evaluated as Good at 200 N/mm, and the workability was evaluated as Good. Furthermore, the retardation Re was evaluated as Good at 30 nm.

### Example 5

In this example, 96 wt. % of TOPAS6013-S04 (manufactured by Polyplastics Co., Ltd.) was compounded as a cyclic olefin resin, and 4 wt. % of Tuftec H1517 (manufactured by Asahi Kasei Corporation) was compounded as a styrene-based elastomer. After this was kneaded at a prescribed temperature within the range of from 210° C. to 300° C. using a twin-screw extruder having a T-die attached to the end thereof (specifications: diameter: 25 mm, length: 26D, T-die width: 160 mm), the cyclic olefin resin composition was extruded at a rate of 250 g/min, and a film with a thickness of 80 μm was wound on a roll.

As illustrated in Table 1, the minor-axis dispersion diameter of the styrene-based elastomer in the TD-thickness (Z-axis) cross section of the film was 0.5 μm. In addition, the tear strength in the MD was evaluated as Good at 43 N/mm, while the tear strength in the TD was evaluated as Good at 90 N/mm, and the workability was evaluated as Good. Furthermore, the retardation Re was evaluated as Good at 3 nm.

### Comparative Example 1

In this comparative example, 65 wt. % of TOPAS6013-S04 (manufactured by Polyplastics Co., Ltd.) was compounded as a cyclic olefin resin, and 35 wt. % of Tuftec H1517 (manufactured by Asahi Kasei Corporation) was compounded as a styrene-based elastomer. After this was kneaded at a prescribed temperature within the range of from 210° C. to 300° C. using a twin-screw extruder having a T-die attached to the end thereof (specifications: diameter: 25 mm, length: 26D, T-die width: 160 mm), the cyclic olefin resin composition was extruded at a rate of 250 g/min, and a film with a thickness of 80 μm was wound on a roll.

As illustrated in Table 1, the minor-axis dispersion diameter of the styrene-based elastomer in the TD-thickness (Z-axis) cross section of the film was 1.9 μm. In addition, the tear strength in the MD was evaluated as Fail at 72 N/mm, while the tear strength in the TD was evaluated as Good at 220 N/mm, and the workability was evaluated as Fail. Furthermore, the retardation Re was evaluated as Fail at 32 nm.

### Comparative Example 2

In this comparative example, Zeonoa ZF16 (manufactured by Zeon Corporation) was used as a cyclic olefin resin, and no styrene-based elastomer was compounded. After this was kneaded at a prescribed temperature within the range of from 210° C. to 300° C. using a twin-screw extruder having a T-die attached to the end thereof (specifications: diameter: 25 mm, length: 26D, T-die width: 160 mm), the cyclic olefin resin composition was extruded at a rate of 250 g/min, and a film with a thickness of 80 μm was wound on a roll.

As shown in Table 1, the tear strength in the MD was evaluated as Fail at 240 N/mm, while the tear strength in the TD was evaluated as Good at 340 N/mm, and the workability was evaluated as Fail. Furthermore, the retardation Re was evaluated as Good at 5 nm.

### Comparative Example 3

In this comparative example, Zeonoa ZM16 (manufactured by Zeon Corporation) was used as a cyclic olefin resin, and no styrene-based elastomer was compounded. After this was kneaded at a prescribed temperature within the range of from 210° C. to 300° C. using a twin-screw extruder having a T-die attached to the end thereof (specifications: diameter: 25 mm, length: 26D, T-die width: 160 mm), the cyclic olefin resin composition was extruded at a rate of 250 g/min, and a film with a thickness of 80 μm was wound on a roll.

As shown in Table 1, the tear strength in the MD was evaluated as Fail at 230 N/mm, while the tear strength in the TD was evaluated as Good at 100 N/mm, and the workability was evaluated as Fail. Furthermore, the retardation Re was evaluated as Fail at 138 nm.

### Comparative Example 4

In this comparative example, TOPAS6013-S04 (manufactured by Polyplastics Co., Ltd.) was used as a cyclic olefin resin, and no styrene-based elastomer was compounded. After this was kneaded at a prescribed temperature within the range of from 210° C. to 300° C. using a twin-screw extruder having a T-die attached to the end thereof (specifications: diameter: 25 mm, length: 26D, T-die width: 160 mm), the cyclic olefin resin composition was extruded at a rate of 250 g/min, and a film with a thickness of 80 μm was wound on a roll.

As shown in Table 1, the tear strength in the MD was evaluated as Good at 42 N/mm, while the tear strength in the TD was evaluated Fail at 42 N/mm, and the workability was evaluated as Fail. Furthermore, the retardation Re was evaluated as Good at 3 nm.

TABLE 1

| | | | | Minor- | | | | |
|---|---|---|---|---|---|---|---|---|
| | | Styrene- | | axis | MD | TD | | |
| | Cyclic olefin | based | Added | dispersion | Tear | Tear | | Retardation |
| | resin | elastomer | amount | diameter | strength | strength | Workability | Re |
| | Trade name | Trade name | [wt.%] | [μm] | [N/mm] | [N/mm] | evaluation | [nm] |
| Example 1 | TOPAS6013-S04 | S.O.E. L606 | 10 | 0.2 | 53 | 165 | Good | 4 (Good) |
| | | | | | (Good) | (Good) | | |
| Example 2 | TOPAS6013-S04 | Tuftec H1517 | 15 | 0.9 | 48 | 145 | Good | 18 (Good) |
| | | | | | (Good) | (Good) | | |
| Example 3 | TOPAS6013-S04 | Tuftec H1517 | 5 | 0.6 | 46 | 105 | Good | 9 (Good) |
| | | | | | (Good) | (Good) | | |
| Example 4 | TOPAS6013-S04 | Tuftec H1517 | 30 | 1.8 | 69 | 200 | Good | 30 (Good) |
| | | | | | (Good) | (Good) | | |
| Example 5 | TOPAS6013-S04 | Tuftec H1517 | 4 | 0.5 | 43 | 90 | Good | 3 (Good) |
| | | | | | (Good) | (Good) | | |
| Comparative | TOPAS6013-S04 | Tuftec H1517 | 35 | 1.9 | 72 | 220 | Fail | 32 (Fail) |
| Example 1 | | | | | (Fail) | (Good) | | |
| Comparative | Zeonoa ZF16 | — | — | — | 240 | 340 | Fail | 5 (Good) |
| Example 2 | | | | | (Fail) | (Good) | | |
| Comparative | Zeonoa ZM16 | — | — | — | 230 | 100 | Fail | 138 (Fail) |
| Example 3 | | | | | (Fail) | (Good) | | |
| Comparative | TOPAS6013-S04 | — | — | — | 42 | 42 | Fail | 3 (Good) |
| Example 4 | | | | | (Good) | (Fail) | | |

When the tear strength in the MD was greater than 70 N/mm and the tear strength in the TD was less than 90 N/mm, as in Comparative Examples 1 to 4, it was difficult to easily cut the film by hand while maintaining toughness. In addition, if the added amount of the styrene-based elastomer was large, as in Comparative Example 1, the retardation Re in the in-plane direction was large. Furthermore, if a styrene-based elastomer was not added, as in Comparative Examples 2 to 4, the desired tear strength in the MD and the TD was not achieved.

On the other hand, when the tear strength in the MD was not greater than 70 N/mm and the tear strength in the TD was not less than 90 N/mm, as in Examples 1 to 5, it was possible to easily cut the film by hand while maintaining toughness. In addition, when the tear strength in the MD was not less than 40 N/mm and the difference between the tear strength in the MD and the tear strength in the TD was not less than 40 N/mm, mechanical anisotropy exhibiting excellent workability was achieved. Furthermore, when the added amount of the styrene-based elastomer was not less than 5 wt. % and not greater than 30 wt. %, retardation Re of not greater than 30 nm was achieved.

### REFERENCE SIGNS LIST

11 Cyclic olefin resin
12 Styrene-based elastomer
13 Inorganic oxide microparticle
21 Die
22 Roll
23 Resin material
31 Phase difference film
32 Hard coat layer
33 Transparent conductive layer
34 Moth-eye structure
40 Touchscreen
41 First transparent conductive film
42 Second transparent conductive film
43 Bonding layer
44 Display
45 Bonding part
46 Glass substrate
47 Bonding layer
48 Polarizer
49 Front panel
50 Bonding layer
51 Bonding layer
100 Television device
101 Display
110 Digital camera
111 Light-emitting part
112 Display
113 Menu switch
114 Shutter button
120 Laptop personal computer
121 Main body
122 Keyboard
123 Display
130 Video camera
131 Main body
132 Lens
133 Start/stop switch
134 Display
140 Mobile telephone
141 Display
150 Tablet computer
151 Display

1. A cyclic olefin resin composition film comprising:
a cyclic olefin resin; and
a styrene-based elastomer,
an average value of minor-axis dispersion diameter of the styrene-based elastomer being not greater than 2.0 μm;
a tear strength of the cyclic olefin resin composition film in a major-axis direction of the styrene-based elastomer being not greater than 70 N/mm; and
a tear strength of the cyclic olefin resin composition film in a minor-axis direction of the styrene-based elastomer being not less than 90 N/mm.

2. The cyclic olefin resin composition film according to claim 1, wherein
the tear strength of the cyclic olefin resin composition film in the major-axis direction of the styrene-based elastomer is not less than 40 N/mm; and
a difference between the tear strength of the cyclic olefin resin composition film in the major-axis direction of the styrene-based elastomer and the tear strength of the cyclic olefin resin composition film in the minor-axis direction of the styrene-based elastomer is not less than 40 N/mm.

3. The cyclic olefin resin composition film according to claim 1, wherein an added amount of the styrene-based elastomer is not less than 5 wt. % and not greater than 30 wt. %.

4. The cyclic olefin resin composition film according to claim 1, wherein a retardation in an in-plane direction is not greater than 30 nm.

5. The cyclic olefin resin composition film according to claim 1, wherein the cyclic olefin resin is an addition copolymer of ethylene and norbornene.

6. The cyclic olefin resin composition film according to claim 1, wherein the styrene-based elastomer is one or more types selected from the group consisting of styrene/ethylene/butylene/styrene block copolymers, styrene/ethylene/propylene/styrene block copolymers, and hydrogenated styrene/butadiene block copolymers.

7. A transparent conductive element comprising the cyclic olefin resin composition film described in claim 1 as a substrate.

8. (canceled)

9. (canceled)

10. (canceled)

11. A production method for a cyclic olefin resin composition film for obtaining a cyclic olefin resin composition film comprising:
heat-melting a cyclic olefin resin and a styrene-based elastomer; and
extruding the heat-melted cyclic olefin resin composition into a film with an extrusion method so as to obtain a cyclic olefin resin composition film;
wherein:
an average value of minor-axis dispersion diameter of the styrene-based elastomer is not greater than 2.0 μm;
a tear strength of the cyclic olefin resin composition film in a major-axis direction of the styrene-based elastomer is not greater than 70 N/mm; and
a tear strength of the cyclic olefin resin composition film in a minor-axis direction of the styrene-based elastomer is not less than 90 N/mm.

12. The cyclic olefin resin composition film according to claim 2, wherein an added amount of the styrene-based elastomer is not less than 5 wt. % and not greater than 30 wt. %.

13. The cyclic olefin resin composition film according to claim 2, wherein a retardation in an in-plane direction is not greater than 30 nm.

14. The cyclic olefin resin composition film according to claim 3, wherein a retardation in an in-plane direction is not greater than 30 nm.

15. The cyclic olefin resin composition film according to claim 2, wherein the cyclic olefin resin is an addition copolymer of ethylene and norbornene.

16. The cyclic olefin resin composition film according to claim 3, wherein the cyclic olefin resin is an addition copolymer of ethylene and norbornene.

17. The cyclic olefin resin composition film according to claim 4, wherein the cyclic olefin resin is an addition copolymer of ethylene and norbornene.

18. The cyclic olefin resin composition film according to claim 2, wherein the styrene-based elastomer is one or more types selected from the group consisting of styrene/ethylene/butylene/styrene block copolymers, styrene/ethylene/propylene/styrene block copolymers, and hydrogenated styrene/butadiene block copolymers.

19. The cyclic olefin resin composition film according to claim 3, wherein the styrene-based elastomer is one or more types selected from the group consisting of styrene/ethylene/butylene/styrene block copolymers, styrene/ethylene/propylene/styrene block copolymers, and hydrogenated styrene/butadiene block copolymers.

20. The cyclic olefin resin composition film according to claim 4, wherein the styrene-based elastomer is one or more types selected from the group consisting of styrene/ethylene/butylene/styrene block copolymers, styrene/ethylene/propylene/styrene block copolymers, and hydrogenated styrene/butadiene block copolymers.

21. The cyclic olefin resin composition film according to claim 5, wherein the styrene-based elastomer is one or more types selected from the group consisting of styrene/ethylene/butylene/styrene block copolymers, styrene/ethylene/propylene/styrene block copolymers, and hydrogenated styrene/butadiene block copolymers.
